(19) United States
(12) Patent Application Publication
(10) Pub. No.: US 2003/0160970 A1
(43) Pub. Date: Aug. 28, 2003

(54) Method and apparatus for high resolution 3D scanning

(76) Inventors: Anup Basu, St. Albert (CA); Irene Cheng, St. Albert (CA)

Correspondence Address: Donald N. Halgren, 35 Central St., Manchester, MA, 01944, US

(21) Appl. No.: 10/253,164

(22) Filed: Sep. 24, 2002

(30) Foreign Application Priority Data
Feb. 27, 2002 (CA) 2,369,710

(51) Int. Cl. G01B 11/24

(52) U.S. Cl. 356/601

(57) ABSTRACT

A method and apparatus for fast high resolution 3D scanning of objects possibly with holes in them includes providing an imaging device, at least one laser pattern projector, sensors adapted to sense a position on an object of a laser pattern projected by the laser pattern projector, sensors adapted to sense the exact identity of the laser patterns that did not fall on the object being scanned, and multiple independent imaging systems coupled with light interference eliminators designed for simultaneously scanning depth and texture data on a 3D object. A computer processor is provided which is adapted to receive from the imaging device a scanned image of an object and adapted to receive from the sensors data regarding the position on the object of the laser pattern projected by the laser pattern projector. The computer processor integrates and registers data from one or more independent imaging systems and sensors to create a high resolution 3D image with accurate depth and texture details.

### FIELD OF THE INVENTION

The present invention relates to fast and accurate acquisition of depth (3D) and simultaneous acquisition of corresponding texture (2D) on an object or person. The present invention also relates to a registration method and an associated apparatus for high resolution 3D scanning using tri-linear or 3 CCD photo sensor arrays. The invention also relates to scanning of objects with voids.

### BACKGROUND OF THE INVENTION

In some applications it is necessary to create a very high resolution 3D image of rigid objects. Some such applications include: recording very high resolution 3D images of artifacts in a museum, sculptures in art galleries, face or body scanning of humans for 3D portraits or garment fitting, goods in departmental stores to be sold through the medium of electronic commerce. Depth information is useful for observing artifacts (such as statues) and structures (such as pillars and columns) that are not 2-dimensional. Depth information is also useful for detecting structural defects and cracks in tunnels, pipelines, and other industrial structures. Depth information is also critical to evaluate goods over the internet, without physical verification of such goods, for possible electronic purchase.

### BRIEF SUMMARY OF THE INVENTION

The present invention comprises a method and an apparatus for high resolution 3D scanning with depth (3D) and corresponding texture (2D) information being acquired in a single pass of the apparatus during the scanning process. According to the present invention there is provided an apparatus for high resolution 3D scanning which includes at least one imaging device, at least one laser pattern projector, and in a further preferred embodiment, one or more illumination devices for capturing texture, sensors adapted to sense a position on an object of a laser pattern projected by the laser pattern projector, and sensors adapted to sense patterns which do not fall on the object being scanned.

A computer processor is provided which is arranged to receive from the imaging device a scanned image of an object and is arranged to receive from the sensors data regarding the position on the object of the laser pattern projected by the laser pattern projector. The computer processor automatically integrates the depth and texture data into a form suitable for high resolution 3D visualization and manipulation.

According to another aspect of the invention there is provided a method for high resolution 3D scanning. A scanning apparatus is provided, as described above. An object is scanned with two or more imaging devices to simultaneously obtain depth and texture information in a single pass of the scanning process. A laser pattern projector is focused upon the object at an angle relative to one imaging device. An illuminating device used for texture scan is focused upon the object at an angle relative to another imaging device. A light interference eliminator is designed to allow simultaneous scanning of depth and texture without light from a laser and another illumination device interfering with one another. The scanned image from the imaging device is transmitted, preferably in digital form, to the computer processor. The computer processor automatically integrates the depth and texture data into a form suitable for high resolution 3D visualization and manipulation.

According to yet another aspect of the invention there is provided a method for detecting projected laser patterns which do not fall on the object being scanned. A scanning apparatus is provided, as described above. An object is scanned with the imaging device to provide a scanned image. The laser pattern projector is focused upon the object at an angle relative to the imaging device. For objects which are composed of multiple components with holes in between, such as a collection of flowers, laser patterns fall on the object of interest and the background alternately. To assist accurate 3D reconstruction in these types of scenarios, sensors are placed behind the object, relative to the imaging sensor and lens, to detect exactly which of the laser patterns did not fall on the object of interest. The scanned image, along with a list of laser patterns that did not fall on the object being scanned for each scanned line, is transmitted to the computer processor, preferably in digital form. The computer processor automatically integrates the depth and texture data into a form suitable for high resolution 3D visualization and manipulation.

According to yet another aspect of the invention there is provided a method for registering data from 3 physically separated CCD arrays, possibly tri-linear CCD arrays. A scanning apparatus is provided as described above. Unlike prior art in texture registration from tri-linear CCDs for translating 2D surfaces, our method for registering texture for rotating objects requires information on the depth of a 3D object to be obtained first and then used in the texture registration process. The computer processor automatically integrates the depth and texture data into a form suitable for high resolution 3D visualization and manipulation.

Although beneficial results may be obtained through the use and operation of the apparatus and method, as described above, it has been determined that rotation can be used to further enhance the results. With small objects, the object can be rotated. For objects that are too large to be rotated or for scenes, it is recommended that the laser pattern projectors be coupled with the imaging device to form a single body. The body can then be rotated as a unit.

The main differences of our invention with other inventions that project one or more patterns are:

(a) the use of tri-linear image sensors with three linear arrays physically separate from one another for sensing Red, Green, and Blue (RGB) colors separately. Tri-linear image sensors are used to create a super high resolution 3D image at a fraction of the cost of generating comparable images using area image sensors. As well, tri-linear image sensors are used to avoid the problem of “image stitching” associated with obtaining a full 360 degree surround view of an object.

(b) A method for registration of the images (texture) obtained by three physically separated R, G, B sensor arrays into one composite RGB image. The method differs from prior art of registration of tri-linear sensor data (U.S. Pat. Nos. 4,278,995 and 6,075,236) in that the depth at various surface locations on a 3D object is needed for accurate registration, and a mathematical formulation including depths of various points on the surface of an object is developed.

(c) The option of using two sets of imaging sensors to simultaneously scan for depth and texture information with independent laser and illumination sources.

(d) The option of using a light interference eliminator designed to eliminate the interference between the said independent laser and illumination sources, and thereby allow simultaneous scanning for depth and texture information on a 3D object or person.

(e) The use of laser pattern receivers which are placed to detect patterns which do not fall on objects being scanned, thereby allowing objects with holes in them to be properly scanned in 3D.

The invention thus comprises a method for high resolution 3D scanning, comprising the steps of: providing at least one tri-linear imaging device; providing a registration method for the images acquired with a tri-linear device that depends on the computed depth; providing at least one light pattern projector adapted to project a light pattern with high definition; providing at least one sensor arranged to sense a position on an object of the light pattern projected by the light pattern projector; providing a light receiving sensor to sense light patterns that fall next to an object being scanned; providing a computer processor and linking the computer processor to the imaging device and the sensors; scanning an object with the at least one imaging device to provide a scanned image; focusing the at least one light pattern projector upon the object at an angle relative to the imaging device; transmitting the scanned image from the imaging device to the computer processor and having the computer processor integrate and register data from one or more independent imaging systems and sensors to create a high resolution 3D image with accurate depth and texture details; precisely rotating said object; coupling the at least one light pattern projector with the imaging device to form a single body; and precisely rotating said body, wherein at least one of the light pattern projectors comprises a laser.

The invention may also comprise a method for high resolution 3D scanning, comprising the steps of: providing at least two independent imaging devices and associated light sources or light pattern projectors; providing one or more light interference eliminators designed to eliminate interference between independent light sources or light pattern projectors; providing a computer processor and linking the computer processor to the imaging device, the sensors and the rotation device; scanning an object with the at least two imaging devices to provide a scanned image comprising depth and texture; transmitting the scanned images from the imaging device to the computer processor and having the computer processor integrate and register data from one or more of the independent imaging systems and sensors to create a high resolution 3D image with accurate depth and texture details; precisely rotating the object; coupling the at least one light pattern projector with the imaging device to form a single body; and precisely rotating the body, wherein one or more light pattern projectors being laser pattern projectors, and wherein one of the independent imaging devices comprise tri-linear or 3 CCD based imaging devices along with method for accurately registering texture from these devices.

The invention may also comprise a method for high resolution 3D scanning, comprising the steps of: providing at least one imaging devices and associated light sources or light pattern projectors; providing sensors adapted to sense a position on an object of laser patterns projected by the at least one light pattern projector; providing sensors adapted to sense the light patterns that fall elsewhere than on an object being scanned; providing a computer processor and linking the computer processor to the imaging device, the sensors and the rotation device; positioning an object on the rotation device and rotating the object; scanning an object with at least one imaging device to provide a scanned image comprising depth and texture; transmitting the scanned images from the imaging device to the computer processor and having the computer processor integrate and register data from one or more of the independent imaging systems and sensors to create a high resolution 3D image with accurate depth and texture details; precisely rotating the object; coupling the at least one light pattern projector with the imaging device to form a single body and precisely rotating the body; wherein one or more light pattern projectors comprise laser pattern projectors, and wherein one or independent imagining devices comprise tri-linear or 3 CCD based imaging devices along with the method for accurately registering texture from these devices.

The invention may also include a method for high resolution 3D scanning, comprising the steps of: providing at least two independent imaging devices and associated light sources or light pattern projectors; providing one or more light interference eliminators designed to eliminate interference between independent light sources or light pattern projectors; providing sensors adapted to sense a position on an object of laser patterns projected by the at least one light pattern projector; providing sensors adapted to sense the light patterns that do not fall on an object being scanned; providing a computer processor and linking the computer processor to the imaging device, the sensors and the rotation device; scanning the object with the at least two imaging devices to provide a scanned image comprising depth and texture; transmitting the scanned images from the imaging device to the computer processor and having the computer processor integrate and register data from one or more independent imaging systems and sensors to create a high resolution 3D image with accurate depth and texture details; precisely rotating the object; coupling the at least one light pattern projector with the imaging device to form a single body and precisely rotating the body; coupling the at least one light pattern projector and the at least one light interference eliminators with the imaging devices and the sensors to form a single body and precisely rotating the body, wherein one or more light pattern projectors being laser pattern projectors, and wherein one or independent imaging devices being tri-linear or 3 CCD based imaging devices along with the method for accurately registering texture from these devices.

### BRIEF DESCRIPTION OF THE DRAWINGS

These and other features of the invention will become more apparent from the following description in which reference is made to the appended drawings, wherein:

FIG. 1 is a block diagram of a first embodiment of an apparatus for high resolution 3D scanning constructed in accordance with the teachings of the present invention.

FIG. 2 is side elevation view of the apparatus for high resolution 3D scanning illustrated in FIG. 1, showing laser projections on to an object.

FIG. 3 is a detailed side elevation view of the apparatus for high resolution 3D scanning illustrated in FIG. 2, showing laser projections from a first projector.

FIG. 4 is a detailed side elevation view of the apparatus for high resolution 3D scanning illustrated in FIG. 2, showing laser projections from a second projector.

FIG. 5 is a block diagram of a second embodiment of an apparatus for high resolution 3D scanning constructed in accordance with the teachings of the present invention.

FIG. 6 is a detailed side elevation view of a component with CCD used in both the first embodiment illustrated in FIG. 1 and the second embodiment illustrated in FIG. 5.

FIG. 7 is a side elevation view relating the projection of two adjacent laser dots on the first 3D surface and corresponding 2D images.

FIG. 8 is a side elevation view relating the projection of two adjacent laser dots on the second 3D surface and corresponding 2D images.

FIG. 9 is a top elevation view showing how different points on an object are scanned at a given instant of time by the R, G, B channels of a tri-linear CCD.

FIG. 10 is a side elevation view relating to the configuration with laser receiver sensors placed to detect laser dots (or patterns) that do not fall on object being scanned.

FIG. 11 shows the R, G, B sensor placement in a typical color area sensor.

FIG. 12 show the R, G, B sensor placement in a typical color linear sensor and a typical greyscale sensor that measures only the intensity I.

FIG. 13 shows R, G, B sensor placement in a typical tri-linear sensor where H is the separation between adjacent color channels.

FIG. 14 shows some of the parameters used in accurate (R, G, B) color registration for a 3D point when using tri-linear sensors.

FIG. 15 an object being rotated and scanned for depth and texture information in a single pass of the scanning process.

FIG. 16 shows the light interference eliminator (LIE) in FIG. 15 in greater detail.

FIG. 17 shows a horizontal cross-section of the LIE in FIG. 15 along with the imaging devices and the rotating platform, all viewed from the top.

FIG. 18 shows an alternative configuration of the proposed apparatus designed to scan a static object or person.

### DETAILED DESCRIPTION OF THE PREFERRED EMBODIMENTS

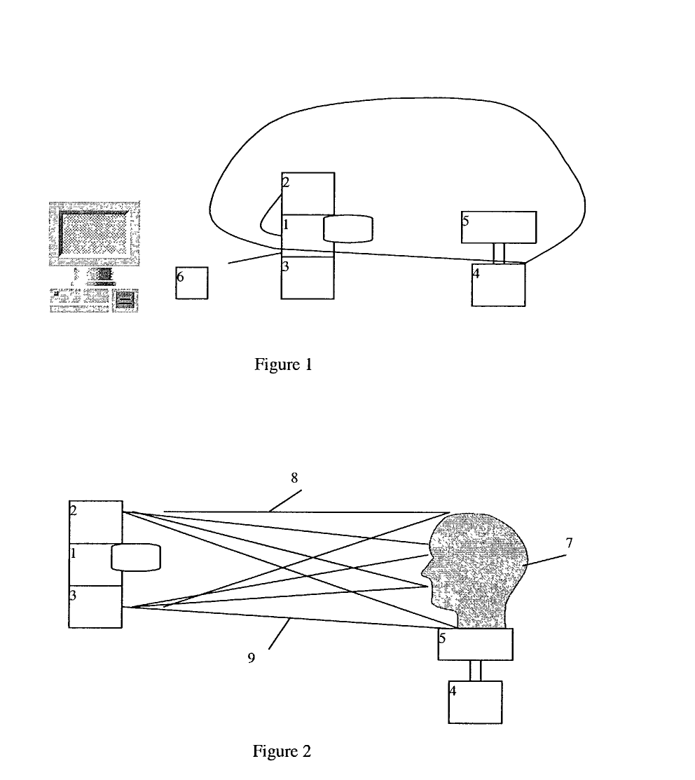

The preferred embodiment, an apparatus for high resolution 3D scanning will now be described with reference to FIGS. 1 through 18.

Referring now to FIG. 1, a high precision rotating unit 4 controls a horizontal platform 5 on which an object may be placed. The object placed on the platform 5 is imaged using a linear CCD based camera 1. Two laser dot (or line) pattern projection devices 2 & 3 are used to project dots or lines on an object placed on platform 5. These dots (or lines) are imaged by the camera 1 to obtain 3D information on the object being imaged. The 3D imaging system is controlled by a computer 6. The electronics in the camera 1 controls the rotation device 4 and synchronizes the image capture with precise movements of the rotation device 4. The 3D data and image texture are transferred from camera 1 to the computer 6 via a bidirectional communication device. It is possible to have other preferred embodiments of the communication and control strategies described herein without having any essential difference from the method and apparatus for 3D imaging described herein. Although there is illustrated and described a laser pattern projector, any light pattern projection capable of projecting a light pattern with good definition may be used. Lasers have been selected for the preferred embodiment as they are commercially available and provide excellent definition. Although beneficial results may be obtained through the use and operation of the apparatus and method, as described above, two or more imaging devices can be used to increase the accuracy of detection of laser patterns and to reduce regions of an object hidden from a single imaging device.

Referring now to FIG. 2, the 3D imaging strategy in the system is shown in greater detail. Two different laser sources 2 & 3 are used to project dot (or line) patterns 8 & 9 respectively on an object placed on the platform 5. The patterns 8 & 9 can be projected at different points in time and imaged by the camera 1 at different points of time; or the patterns 8 & 9 may be projected simultaneously but using lasers of different wavelengths sensitive to different color sensors, and imaged using different color sensors in a tri-linear sensor, or a sensor consisting of more than one type of color sensor, contained in camera 1. The method of projecting 8 & 9 simultaneously using lasers of different wavelengths is preferable for avoiding repeatedly turning lasers 2 & 3 on and off, resulting in faster scanning of depth related information and longer life of the laser projection devices and related hardware. Depth related information using laser patterns 8 & 9 and image texture under indoor lighting on an object placed on platform 5 may be obtained either during a single rotation of the object if lasers 2 & 3 are turned on and off at each step of movement of the rotation unit 5, or during two rotation cycles of the object with one cycle being used to obtain depth related data while the other cycle being used to obtain image texture. Two rotation cycles, one in which texture is scanned and another in which depth related information is acquired, is preferable when it is not desirable to turn lasers on and off for each line scan.

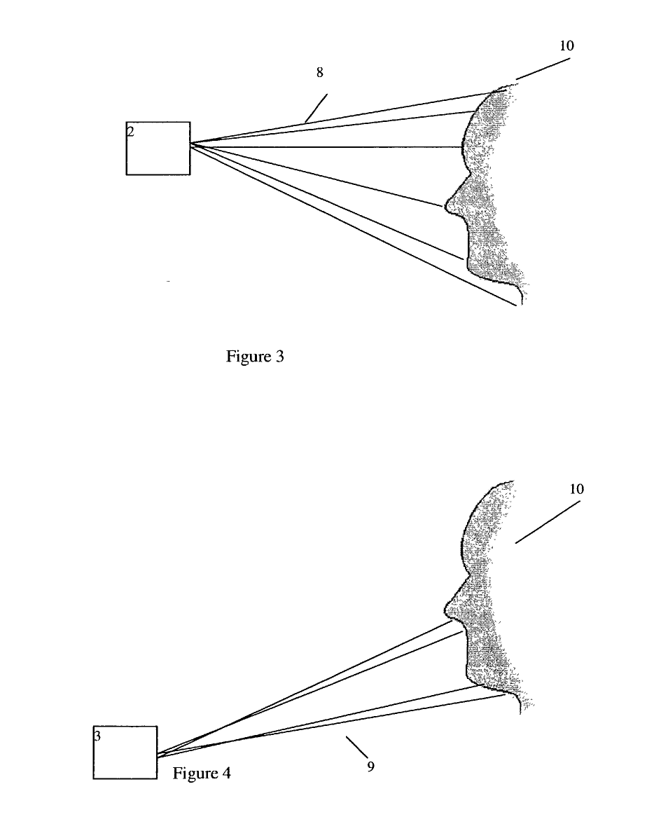

Referring now to FIG. 3, the laser pattern projection from laser projector 2 is shown. Note that parts of the face object, such as parts under the nose and under the chin are hidden from the projection rays of laser projector 2. These hidden parts constitute sections of the object where texture information is available but depth information is not available; the hidden parts are a major drawback of traditional 3D scanning devices.

Referring now to FIG. 4, the laser pattern projection from laser projector 3 is shown. Note that parts of the face object, such as parts under the nose and under the cheek that were hidden from the projection rays of the laser projector 2 can be reached by laser projector 3. Eliminating the regions hidden by laser projector 2 constitutes a major advantage of the method and apparatus described in this disclosure. It is possible to have other variations in the arrangement of two or more laser projection devices and one or more CCD sensors in order to eliminate the hidden regions described herein without having any essential difference from the method and apparatus for 3D imaging described herein.

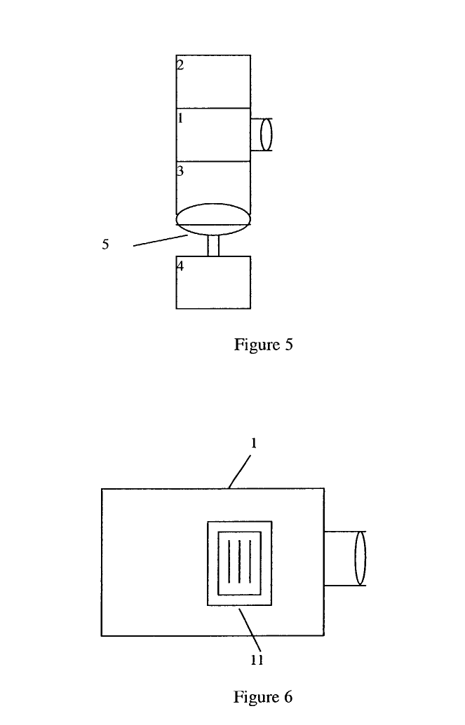

Referring now to FIG. 5, another preferred embodiment of the device and apparatus which contrasts the embodiment in FIG. 1 is shown. The arrangement in FIG. 5 is suitable for 3D scanning of sections of large objects or for 3D scanning of interior of buildings etc. In FIG. 5 an imaging device 1 is placed along with two laser projection devices 2 & 3 on top of a platform 5 mounted on a high precision rotation unit 4. Note that parts of an object or scene visible from the imaging device 1 but hidden from the laser projector 2 can be reached by rays from the laser projector 3. Again, eliminating the regions hidden by laser projector 2 constitutes a major advantage of this embodiment of the method and apparatus described in this patent. It is possible to have other variations in the arrangement of two or more laser projection devices and one or more CCD sensors in order to eliminate the hidden regions described herein without having any essential difference from the method and apparatus for 3D imaging described herein. Although beneficial results may be obtained through the use and operation of the apparatus and method, as described above, two or more imaging devices can be used to increase the accuracy of detection of laser patterns and to reduce regions of an object hidden from a single imaging device.

The primary differences of our invention with other inventions that project multiple patterns are:

(a) The use of tri-linear image sensors with three linear arrays physically separate from one another for sensing Red, Green, and Blue colors separately. Tri-linear image sensors are used to create a super high resolution 3D image at a fraction of the cost of generating comparable images using area image sensors. For example, a 10,000 pixel linear CCD from Kodak can be purchased for around $1,000 whereas a 10,000×10,000 area CCD from Kodak can cost closer to $100,000. As well, tri-linear image sensors are used to avoid the problem of “image stitching” associated with obtaining a full 360 degree surround view of an object. Image stitching is necessary to create a panoramic or 360 degree composition of several snapshots taken with an area CCD camera.

(b) A method for registration of the images (texture) obtained by three physically separated R, G, B sensor arrays into one composite RGB image. The method differs from prior art of registration of tri-linear sensor data (U.S. Pat. Nos. 4,278,995 and 6,075,236) in that the depth at various surface locations on a 3D object is needed for accurate registration, and a mathematical formulation including depths of various points on the surface of an object is developed.

(c) The option of using two sets of imaging sensors to simultaneously scan for depth and texture information with independent laser and illumination sources. This option increases the speed of high resolution 3D capture significantly, making tasks like 3D scan of a person's head possible.

(d) The option of using a light interference eliminator (LIE) designed to eliminate the interference between the said independent laser and illumination sources, and thereby allow simultaneous scanning for depth and texture information on a 3D object or person. The option in (c) above may not work without the addition of a LIE.

(e) The use of laser pattern receivers which are placed to detect patterns which do not fall on objects being scanned, thereby allowing objects with holes in them to be properly scanned in 3D.

Referring now to FIG. 6, the location of a linear (or tri-linear) CCD array 11 is shown in the imaging device 1. The location of the CCD array 11 needs to be precisely calibrated with respect to the line of projection of dots from laser projectors 2 & 3; the CCD array and the laser projectors need to be precisely aligned to project and image from the same vertical 3D object segment at any given step. It must be noted that because of the physical separation of the red, green and blue sensors in a tri-linear CCD, physical characteristics of the sensor, focal length of the imaging system, the 3D measurements on the object being scanned, and the precision of the rotating device, all have to be taken into account to accurately merge the images acquired by the red, green, and blue sensors into a composite color picture.

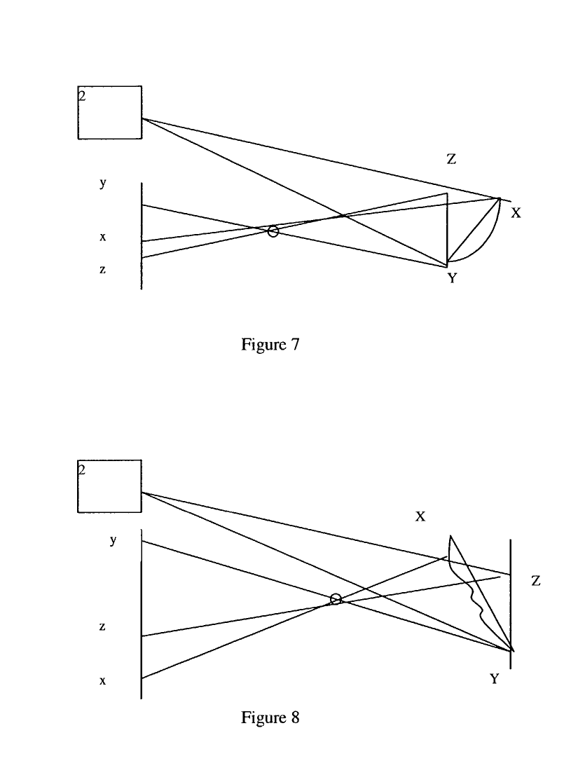

Referring now to FIG. 7, the depth of a location in 3D can be computed relative to the depth of a neighboring location, where neighboring locations are defined as locations on an object where adjacent laser dots (or lines) are projected in a vertical axis. Consider a location Y on an object surface on which a ray from the laser projector 2 falls, the projection of this location on the CCD 11 is at the position y. Consider now a neighboring location X for which the projection on the CCD 11 is at position x. If the distance of X from the imaging system 1 is further than the distance of Y from the imaging system 1 then the position x is closer to y than where X would have projected (z) if X were at the same distance from the imaging system 1 as Y. By contrast, FIG. 8 shows that if the distance of X from the imaging system 1 is closer than the distance of Y from the imaging system 1 then the position x is further from y than where X would have projected (z) if X were at the same distance from the imaging system 1 as Y.

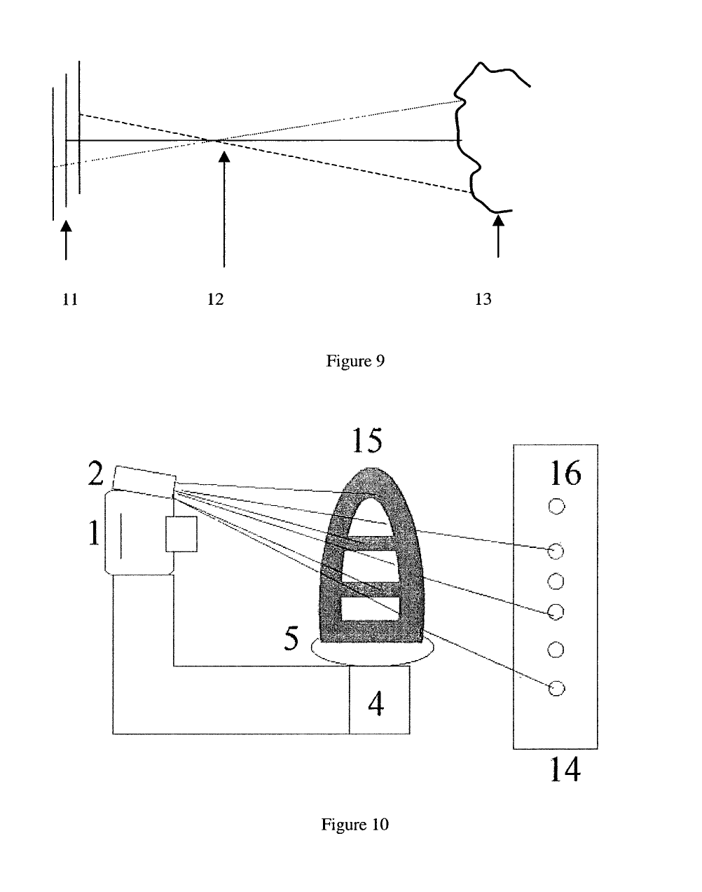

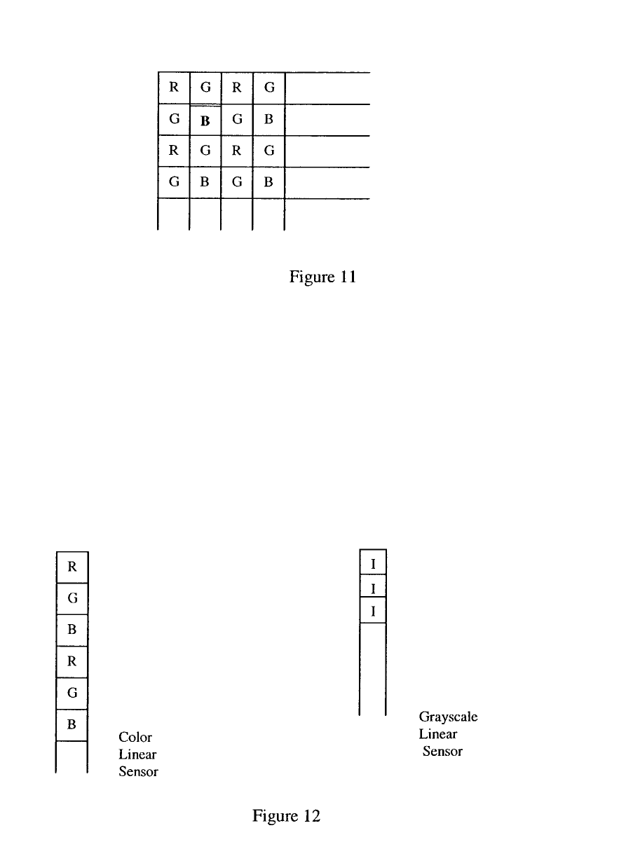

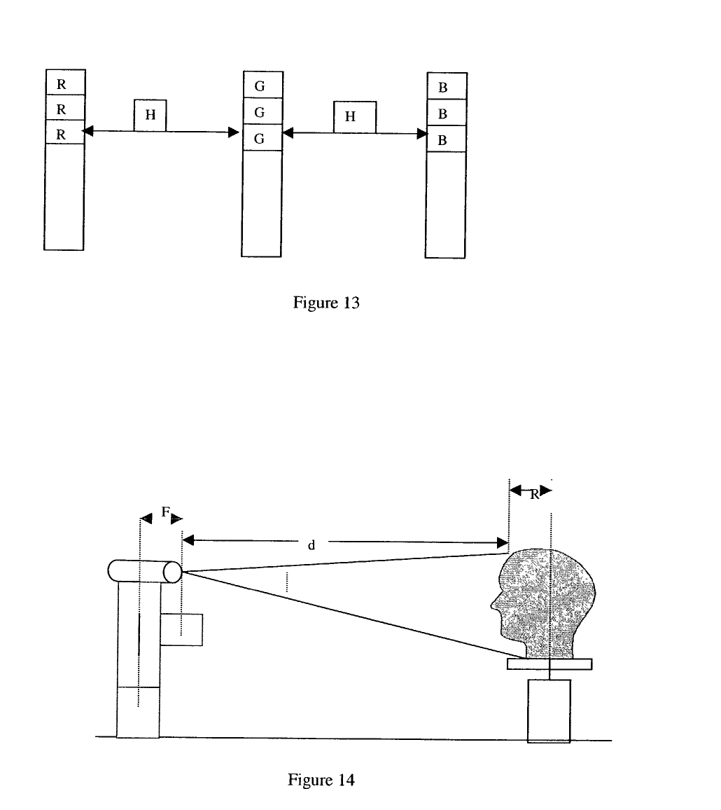

Referring now to FIG. 9, different points from a horizontal section of an object 13 being scanned is shown to project through the optical center of a lens of camera 1 to different vertical sensor arrays 11 representing the R, G, B channels of a tri-linear CCD sensor. The tri-linear sensors are physically separated by a distance of several micrometers (μm); refer to FIG. 13 for the configuration of a tri-linear sensor which is different from area sensors (FIG. 11) and linear sensors (FIG. 12). For example, tri-linear CCDs manufactured by Kodak, Sony, or Phillips may have a distance of 40 μm between adjacent Red and Green sensors. As a result of this physical separation different locations on a 3D scene are captured by adjacent Red, Green, and Blue sensors lying on a tri-linear CCD at any given instant of scanning. For registering the R, G, B values at the same 3D location it is necessary to create an (R,G,B) triple where the R, G, B values are selected from three different scanning instants. Selecting the different instants from which a particular (R, G, B) triple needs to be created is not an obvious task and needs careful mathematical modelling. The formulation depends on the focal length (F) of the lens, the depth (d) of a 3D point, the horizontal separation (H) between two adjacent color channels, the number of steps (N) per 360 degree revolution, and the horizontal distance (R) of the axis of rotation from the location of the 3D point for which the colors are being registered. Prior art dealing with registration of images from tri-linear sensors do not address issues relating to 3D scanning of a non-planar rotating object. FIG. 14 describes the various parameters needed in the tri-linear sensor texture registration process. It can be shown that:

Shift required to match adjacent colors (e.g., Red & Green say) for a 3D point in a small region of an object being scanned=(N*d*H)/(2*π*R*F).

The above formula can be derived as follows:

R=local radius of object around region being scanned.

N=number of steps per 360 degree revolution.

Thus, 2*π*R=local circumference of object around region being scanned. Hence, around region being scanned by a specific laser pattern, 1 step=(2*π*R)/N units on the object surface.

From perspective geometry and similar triangles it can be shown that a distance of H (the distance between adjacent color sensors) on the image plane=(d*H)/F on the object surface at a distance d from the optical center.

From the previous two statements it follow that the separation of adjacent color sensors is equivalent to:

((d*H)/F)/(2*π*R/N)=(N*d*H)/(2*π*R*F) steps of rotation of the object.

When the scanner rotates and the object is static, as in FIG. 5, it can be shown that to register two adjacent colors the number of steps of shift required=(N*H)/(2*π*F). In this case the distance to a point on an object, and the local radius of an object, do not affect the number of steps of shift to register adjacent colors.

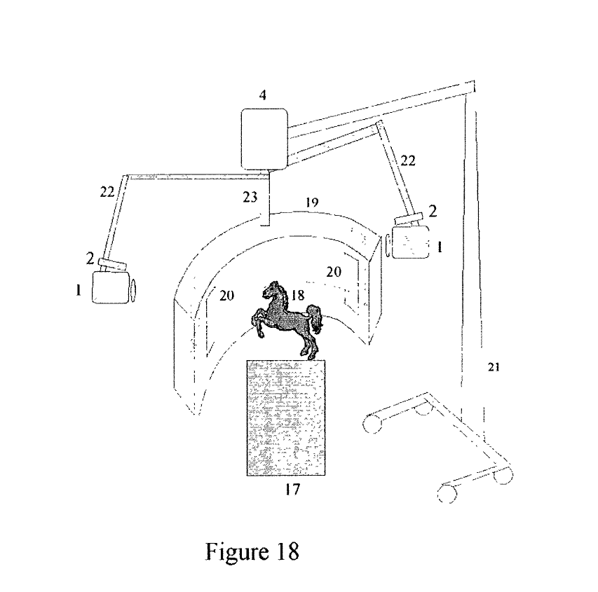

When the scanner rotates around an object supported by a rotating arm of length L, as shown in FIG. 18, it can be shown that to register two adjacent colors the number of steps of shift required=(N*H)/(2*π*L), assuming L is significantly larger than F the focal length of the imaging system. In this case the distance to a point on an object, and the local radius of an object, do not affect the number of steps of shift to register adjacent colors.

In the above derivations * denotes multiplication, / denotes division, and π is the mathematical constant. Note that the formulation here is quite different from the registration methods described in the prior art. In our method and apparatus of the present invention, it is necessary to first compute the 3D measurements of a point on the surface of an object in order to correctly register the R, G, B values of a texture pixel. The 3D measurements are necessary to estimate the parameters d and R at a given pixel. As the d and R values change from one point of a 3D surface to another, so does the shift required to match adjacent colors at a given pixel. Table 1 below shows the shift values for various d and R values, assuming all other parameters are fixed and (d+R)=the distance between optical center of the lens and the center of the object rotating platform is fixed.

TABLE 1
Variation of shift values with changes in 3D surface properties.

| | | Shift to match adjacent | |
|---|---|---|---|
| d (in cm) | R (in cm) | colors | |
| 10 | 1 | | S |
| 9 | 2 | 0.55 | S |
| 10.5 | 0.5 | 2.1 | S |
| 5.5 | 5.5 | 0.1 | S |

Considering Table 1, if S computed to 100 in row 1 for a given set of parameters, S would compute to 55 in row 2, 210 in row 3, and 10 in row 4 for the same set of parameters of a 3D imaging system.

Note that the formulation is quite different from simple situations like a flatbed scanner where the distance between the strips captured by two color channels is only related to the physical separation of the two color channels on a tri-linear CCD sensor or the variable resolution scanning process as described in prior art. In fact an estimate of the depth (d) of a 3D point on an object needs to be used in registration of the surface texture of the 3D object, making the process significantly different and not obviously deducible from models using area or linear sensors or prior art. The advantage of the tri-linear sensor, over configurations in FIG. 11 and FIG. 12 (left), lies in recording R, G and B values at the same 3D location producing “true 3 CCD color”; only the configuration in FIG. 12 (right) can achieve similar quality with three scans using red, green and blue filters; however such a process results in a much slower system.

Referring now to FIG. 10, a modified version of the device and apparatus described thus far is shown. The modification relates to addition of the capability to scan a 3D object 15 which may have surfaces with holes in them. In order to scan such objects, a block 14 of laser receiver sensors 16 are placed behind the rotating platform 4, 5. Laser dots or patterns which do not fall on the object being scanned are detected by the laser receivers 16. This makes it possible to determine exactly which laser patterns fell on the object 15 and which did not. Variations of the apparatus in FIG. 10 can be made to accommodate scanning of static objects extending the configuration in FIG. 5. Variations of the apparatus in FIG. 10 can be made to accommodate using multiple lasers (e.g., 2, 3 and others) or one or more cameras in addition to 1.

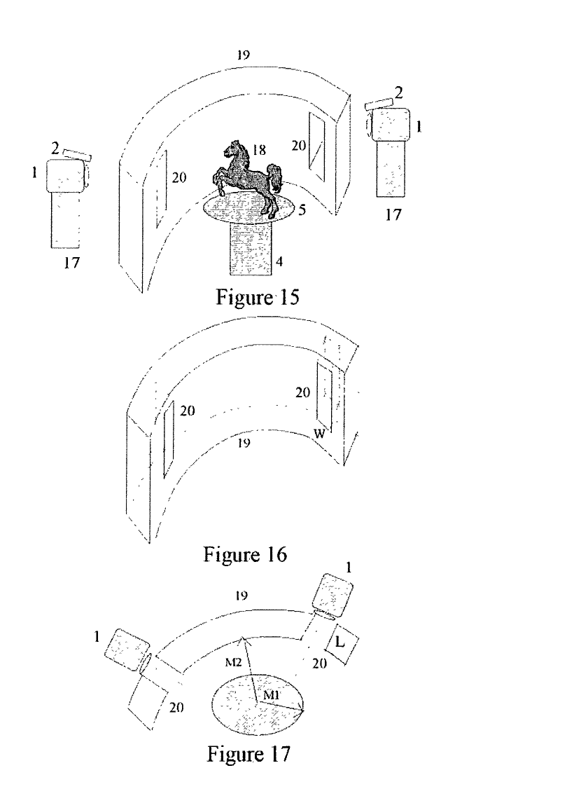

Referring now to FIG. 15, a modified version of the device and apparatus described thus far is shown. The modification relates to addition of the capability to simultaneously scan for the depth and texture on a 3D object 18. The simultaneous depth and texture scan is achieved by introducing an extra imaging device 1 along with an extra light source 2 used to illuminate a vertical strip of the object 18, and a light interference eliminator (LIE) 19 to eliminate interference between lighting (possibly structured laser) for depth scan and lighting for texture illumination. Static supporting platforms 17 are used to adjust the height and locations of the independent imaging devices 1 along with attached light or laser sources 2. Note that the modifications shown in FIG. 10 can be added to modifications in FIG. 15 in order to facilitate scanning objects with voids.

Referring now to FIG. 16, the LIE 19 is shown in greater detail identifying the structure of the vertical slits 20 that allow lighting to fall on an object 18 being scanned from two sources without any interference between the light sources.

Referring now to FIG. 17, a horizontal cross-section of the LIE 19 is shown viewed from the top along with two independent imaging devices 1. M1 refers to the smallest radius of an object being scanned and M2 refers to the largest radius of an object being scanned. Let W and L refer to the width and length, respectively, of a vertical slit 20, and a denote the angle between the optical axes of the two independent imaging devices 1. It can be shown that in order to avoid interference between the independent light or laser sources 2 in FIGS. 15 and 18 the following relationship must be satisfied:

W/L<(M1 tan α)/(M2−M1)

Where “tan” refers to the tangent of an angle.

Referring now to FIG. 18, a modified version of the device and apparatus described in FIG. 15 is shown. The modification relates to addition of the capability of rotating the scanning hardware around an object or a person to obtain the depth and texture on a 3D object 18. The simultaneous depth and texture scan is achieved by an extra imaging device 1 along with an extra light source 2 used to illuminate a vertical strip of the object 18, and a light interference eliminator (LIE) 19 to eliminate interference between lighting (possibly structured laser) for depth scan and lighting for texture illumination. A support structure 21 is used to allow the scanning hardware to hang freely and be rotated by a rotating device 4 whose output shaft is firmly attached to the LIE 19 and to two independent images devices 1 and light or laser sources 2 by means of adjustable mechanical arms 22 and a shaft extender 23. Note that the modifications shown in FIG. 10 can be added to modifications in FIG. 18 in order to facilitate scanning objects with voids.

Note that FIGS. 1 to 8 describe background subject matter, and FIGS. 9 to 18 relate more to the innovative components in our proposed method and apparatus.

In operation, the computer 6 controls the rotating device 4 to move one step at a time to turn up to 40,000 steps or more per 360 degree revolution. The number of steps can be higher than 40,000 per 360 degree using a different set of stepper motor and gear head. At each step the imaging system 1 acquires a high resolution linear strip of image along with depth information obtained through the projection of dot (or line) patterns projected by laser projectors 2 and 3. The projection rays from projectors 2 and 3 are 8 and 9 respectively as shown in FIG. 2. An object 7 is imaged in two modes, in one mode texture on the object is acquired under normal lighting, in another mode depth information on the object is acquired through the projection of laser dots (or lines) from the two sources 2 and 3. It is preferable to use a flat platform 5 on which an object 7 can be placed; however, other means of rotating an object may be employed without changing the essence of the system. In order to have a point of reference for the location of the laser dots (or lines) the projectors 2 and 3 are calibrated to project the vertically lowest dot (or line) on to known fixed locations on the platform 5.

One of the major drawbacks of many existing 3D scanners is that regions on which texture is acquired by an imaging device may not have depth information available as well, leading to regions where depth information can only be interpolated in the absence of true depth data. To avoid this problem two laser projectors 2 and 3 are used in the proposed system. For example, in FIG. 3 regions under the nose and chin in the face shape 10 cannot be reached by the laser rays 10 from the laser projector 2; in the absence of laser projector 3 with additional laser rays 9 true depth information cannot be computed in these regions. With the addition of laser projector 3 regions visible from the imaging sensor 1 but which could not be reached by the rays 8 from laser projector 2 can now be reached by the rays 9 from laser projector 3. There can be other variations in the arrangement of two or more laser projectors with the purpose of eliminating hidden regions without changing the essence of this invention as described in the present system.

In operation, one or more methods can be used to differentiate the rays 8 and 9 from the laser projectors 2 and 3. One method consists of using lasers with different wavelengths for projector 2 and projector 3. For example, laser projector 2 may use a wavelength of 635 nm which can be sensed only by the red sensor of a tri-linear sensor 11 while 3 may use a wavelength of 550 nm which can be sensed primarily by the green sensor of a tri-linear sensor 11 allowing both laser projectors 2 and 3 to project patterns at the same point in time; alternately, if 2 and 3 both used lasers of wavelength of 600 nm, as an example, the lasers can be sensed by both the red and green sensors in 11, but with lower intensity than in the first example. Another method of differentiating between the rays generated by projectors 2 and 3 consists of turning on projector 2 and projector 3 alternately, thereby having either rays 8 or rays 9 project onto an object surface; this method can use lasers with the same wavelength but will require more scanning time than the first method.

Another major drawback of many existing 3D scanners is that objects which are composed of components with holes in between the components are difficult to scan. Examples of such objects include a cup or a teapot which has a handle or a lip, a bunch of flowers, a mesh with a collection of holes on the surface, etc. To address this drawback, sensors 16 are added which can detect the laser patterns which go through the holes on the object being scanned and fall on the background.

The apparatus and method described provide a unique way of creating a 3D image with very high resolution texture. The apparatus and method also provide for computer controlled electronics for real-time modifications to the camera imaging parameters. The apparatus uses a single high precision rotation unit and an accurately controlled laser dot (or line) pattern, with a very resolution tri-linear CCD array that is used to image both the laser dot (or line) pattern and object texture, to produce a very high resolution 3D image suitable for high quality digital recording of objects. A tri-linear CCD, referred to as tri-linear sensor in the claims, is used to compute depth directly at the locations where the laser dots (or lines) are projected. The depth values are registered with the locations of image texture, and 3D modelling techniques are used to perform 3D texture mapping. Multiple laser dot (or line) patterns are used to avoid the problem of hidden regions encountered by traditional 3D scanners. A set of laser receivers matching the number of laser patterns projected is used to detect laser patterns that do not fall on the object being scanned.

The apparatus and method as described thus far had the drawback that two scans are needed, one for obtaining depth from laser pattern projection and another for obtaining surface texture from photographic illumination, before a realistic 3D shape with high resolution depth and texture is acquired. Multiple sequences of scanning makes it difficult to capture a person's face in 3D, for example, since a means to hold the same pose for an extended period of time has to be put in place. In order to speed up the scanning process two independent imaging systems 1 are introduced along with corresponding lighting or laser attachments 2 in FIGS. 15 and 18. The aforesaid independent lighting systems 2 must not interfere with one another; for example, laser projected from the lighting source 2 on the left in FIG. 15 should not be visible by the imaging system 1 responsible for texture acquisition, say, on the right in FIG. 15. In order to avoid the aforesaid “interference” problem, a Light Interference Eliminator (LIE) 19 is introduced. The LIE allows lighting from an objects or a person 18 being scanned to be visible only through a vertical slit 20. By adjusting the length (L) and width (W) of a slit with respect to the minimum (M1) and maximum (M2) radii of an object being scanned, and the angle (α) between the optical axes of the two imaging systems 1 passing through the slits (20), it can be ensured that there is no lighting interference between two independent imaging systems operating simultaneously. Based on a careful geometric analysis it can be shown that the following relationship must be satisfied in order to guarantee the avoidance of interference:

W/L<(M1 tan α)/(M2−M1)

For example, the width (W) of a slit may need to be reduced or the length (L) may need to be increased to avoid interference should the independent imaging systems be placed closer to one another reducing the angle a in the process.

It will be apparent to one skilled in the art that modifications may be made to the illustrated embodiment without departing from the spirit and scope of the invention as hereinafter defined in the claims.

We claim:

1. A method for high resolution 3D scanning, comprising the steps of:
providing at least one tri-linear imaging device;
providing a registration method for the images acquired with a tri-linear device that depends on the computed depth;
providing at least one light pattern projector adapted to project a light pattern with high definition;
providing at least one sensor arranged to sense a position on an object of the light pattern projected by the light pattern projector;
providing a light receiving sensor to sense light patterns that fall next to an object being scanned;
providing a computer processor and linking said computer processor to said imaging device and said sensors;
scanning an object with said at least one imaging device to provide a scanned image;
focusing said at least one light pattern projector upon said object at an angle relative to said imaging device;
transmitting said scanned image from said imaging device to said computer processor and having said computer processor integrate and register data from one or more independent imaging systems and sensors to create a high resolution 3D image with accurate depth and texture details.

2. The method as defined in claim 1, including the further step of:
precisely rotating said object.

3. The method as defined in claim 1, including the further step of:
coupling said at least one light pattern projector with said imaging device to form a single body; and precisely rotating said body.

4. The method as defined in claim 1, at least one of the light pattern projectors comprising a laser.

5. A method for high resolution 3D scanning, comprising the steps of:
providing at least two independent imaging devices and associated light sources or light pattern projectors;
providing one or more light interference eliminators designed to eliminate interference between independent light sources or light pattern projectors;
providing a computer processor and linking the computer processor to said imaging device, said sensors and said rotation device;
scanning an object with said at least two imaging devices to provide a scanned image comprising depth and texture;
transmitting said scanned images from said imaging device to said computer processor and having said computer processor integrate and register data from one or more of said independent imaging systems and sensors to create a high resolution 3D image with accurate depth and texture details.

6. The method as defined in claim 5, including the further step of:
precisely rotating the object.

7. The method as defined in claim 5, including the further step of:
coupling said at least one light pattern projector with said imaging device to form a single body; and
precisely rotating the body.

8. The method as defined in claim 5, where one or more light pattern projectors being laser pattern projectors.

9. The method as defined in claim 5, where one of said independent imaging devices comprise tri-linear or 3 CCD based imaging devices along with method for accurately registering texture from these devices.

10. A method for high resolution 3D scanning, comprising the steps of:
providing at least one imaging devices and associated light sources or light pattern projectors;
providing sensors adapted to sense a position on an object of laser patterns projected by said at least one light pattern projector;
providing sensors adapted to sense said light patterns that fall elsewhere than on an object being scanned;
providing a computer processor and linking said computer processor to said imaging device, said sensors and said rotation device;
positioning an object on said rotation device and rotating said object;
scanning an object with at least one imaging device to provide a scanned image comprising depth and texture;
transmitting said scanned images from said imaging device to said computer processor and having said computer processor integrate and register data from one or more of said independent imaging systems and sensors to create a high resolution 3D image with accurate depth and texture details.

11. The method as defined in claim 10, including the further step of:
precisely rotating the object.

12. The method as defined in claim 10, including the further step of:
coupling said at least one light pattern projector with said imaging device to form a single body and precisely rotating said body.

13. The method as defined in claim 10, where one or more light pattern projectors being laser pattern projectors.

14. The method as defined in claim 10, where one or independent imaging devices comprising tri-linear or 3 CCD based imaging devices along with method for accurately registering texture from these devices.

15. A method for high resolution 3D scanning, comprising the steps of:
providing at least two independent imaging devices and associated light sources or light pattern projectors;
providing one or more light interference eliminators designed to eliminate interference between independent light sources or light pattern projectors;
providing sensors adapted to sense a position on an object of laser patterns projected by the at least one light pattern projector;
providing sensors adapted to sense the light patterns that do not fall on an object being scanned;
providing a computer processor and linking said computer processor to said imaging device, said sensors and said rotation device;
scanning said object with said at least two imaging devices to provide a scanned image comprising depth and texture;
transmitting said scanned images from said imaging device to said computer processor and having said computer processor integrate and register data from one or more independent imaging systems and sensors to create a high resolution 3D image with accurate depth and texture details.

16. The method as defined in claim 15, including the further step of:
precisely rotating the object.

17. The method as defined in claim 15, including the further step of:
coupling said at least one light pattern projector with said imaging device to form a single body and precisely rotating said body.

18. The method as defined in claim 15, including the further step of:
coupling said at least one light pattern projector and said at least one light interference eliminators with said imaging devices and said sensors to form a single body and precisely rotating said body.

19. The method as defined in claim 15, where one or more light pattern projectors being laser pattern projectors.

20. The method as defined in claim 15, where one or independent imaging devices being tri-linear or 3 CCD based imaging devices along with method for accurately registering texture from these devices.
